(19) United States
(12) Patent Application Publication
(10) Pub. No.: US 2010/0299167 A1
(43) Pub. Date: Nov. 25, 2010

(54) TECHNOLOGY ENTERPRISE MANAGEMENT APPARATUS AND METHOD THEREFOR

(76) Inventor: Paul Mulvanny, Herefordshire (GB)

Correspondence Address: BRACEWELL & GIULIANI LLP, P.O. BOX 61389, HOUSTON, TX, 77208-1389, US

(21) Appl. No.: 12/740,728

(22) PCT Filed: Oct. 29, 2008
(86) PCT No.: PCT/GB2008/051016

§ 371 Date: Aug. 9, 2010

(30) Foreign Application Priority Data
Oct. 31, 2007 (GB) 0721388.7
Aug. 27, 2008 (GB) 0815552.5
Aug. 28, 2008 (GB) 0815652.3

(51) Int. Cl. G06Q 10/00

(52) U.S. Cl. 705/7

(57) ABSTRACT

A technology enterprise management apparatus comprises a processing resource (112, 114, 116, 118) arranged to support a stage and gateway process (400) having a plurality of stages (406, 412, 418, 424, 430, 436) and a plurality of gateways (402, 408, 414, 420, 426, 432, 438) interlaced with the plurality of stages. The processing resource also supports a plurality of stage engineering module structures (600) respectively associated with the plurality of stages, each of the stage engineering module structures (600) supporting, at least in part, a function (422, 444, 446, 448, 450, 452) associated with the stage and gateway process. A database (110) is accessible by the processing resource (118) and arranged to permit storage of data at least relating to the function. The processing resource is further arranged to monitor an assessment of the function at a stage of the stage and gateway process and to manage progression to a succeeding adjacent stage of the stage and gateway process in response to the assessment.

The present invention relates to a technology enterprise management apparatus of the type that, for example, supports a technology enterprise model for evolving maturity of a design configuration. The present invention also relates to a method of modelling a technology enterprise, the method being of the type that, for example, supports a technology enterprise model for evolving maturity of a design configuration.

In recent times, the application of practical sciences has become more complex for a variety of reasons. A significant reason is the amount of knowledge which must be coordinated in order to enable highly developed technology to function in today's society. It is often the case that costs associated with the delivery of a solution, which needs highly developed technology, cannot be justified in a business case for a single deployment of the solution. It is sometimes not appreciated that certain aspects of the solution are inextricably, and sometimes explicitly, linked to aspects internal and/or external to an organisation that are not perceived as directly relating to the engineering of the solution.

Furthermore, failure of technologies to interface effectively on a number of levels, for example, social and technical, can cause business cases for investment in a project to fail. A resulting decision not to invest can lead to a lack of competitiveness in a business. Conversely, a decision to invest in respect of the project can, in some instances, result in an anticipated return on investment not being fulfilled.

In the context of product development, a challenge exists in matching market needs on one side with capabilities of suppliers on another side. In this respect, on the market side, for a given market sector associated with an enterprise, there is a considerable number of projects in progress to satisfy various market scenarios. The projects translate into an even larger number of technology applications that have to be implemented in order to achieve completion of the projects. As a result, an extremely large number of performance attributes or parameters, for example those characterising social, technical and business aspects of the engineering, exist in connection with the various projects. On the supply side, a given supply organisation has a number of operations that support delivery of the projects, the various operations performing a larger number of tasks in their respective roles supporting the organisation. A considerable number of technology attributes or parameters are associated with the tasks. In the light of the vast numbers of both performance attributes and technology attributes, the challenge in matching the market needs with the capabilities of suppliers is therefore complex. Indeed, a given enterprise will have many concurrent technology applications at different stages of development at any one time.

In an attempt to simplify matters, enterprise modelling represents, typically computationally, structures, activities, processes, information, resources, people, behaviours, goals, and/or constraints of a business, government, or other enterprises, entity or programme. Such representation includes not only relationships with internal structures of the organisation, but also with the environment with which the organisation interacts. The purpose of such representations is to serve as a tool to enable effective management of an enterprise in the light of the complex structures, processes and inter-relationships associated with the enterprise.

Enterprise models can be broadly categorised into two classes: static and dynamic. A static enterprise model is a “snapshot” of the organisation at a particular instant in time. The snapshot can include, inter alia, information concerning the structure of the organisation, boundaries with external entities, process information, strategic objective information, information concerning external influences on the organisation and/or Strength-Weakness-Opportunity-Threats (SWOT) analysis results.

In contrast, a dynamic enterprise model, as its name suggests, represents changes of the organisation with time.

Enterprise models are employed for many different purposes. One example of an application of an enterprise model is for business strategic purposes, where it is necessary to identify and implement business strategies for an organisation to succeed. Organisation and process design is another application of the enterprise model and is particularly useful where it is necessary to implement management and/or operational improvements in an organisation. Enterprise models are also used in relation to Information Technology (IT) planning where cost sensitivity is a concern in relation to most or all aspects of the IT, but particularly procurement and deployment. The enterprise model can also extend to organisational structures to support the IT and policies to support development coordination.

It is known to employ enterprise models in relation to so-called requirements and system development. In this context, the enterprise model is a technology enterprise model and is used to define requirements for applications, system developments, and planning of transitioning and/or bridging from legacy systems to new systems.

U.S. Pat. No. 6,442,557 relates to a memory for storing data for access by a database program for evaluating an enterprise structure. The memory stores a data structure, the data structure including information resident in the database. The data structure includes a work flow model, an information model, and a technology model. The data structure provides a user with an opportunity to analyse dependencies between the structure and function of an enterprise and the information technology relied upon by the enterprise in order to determine the impact of information technology changes upon enterprise structure and function. This document additionally makes reference to the US Department of Defence (DoD) Technical Architecture Model for Information Management (TAFIM). In particular, reference is made to the DoD Standards-based Architecture Planning Guide, Volume 4 of the TAFIM, which introduces a conceptual model for describing enterprise architectures including both organisational and technological components as well as inter-relationships therebetween. The model provides sufficient detail concerning an architecture of an enterprise to support strategic decision-making concerning future technology investment. Using the model, it is also possible to obtain guidance for engineers who develop and maintain detailed system architectures for specific automated systems.

Patent Cooperation Treaty (PCT) publication no. WO 2004/046878 relates to a client-server arrangement for supporting an “enterprise architecture”, a number of business applications being executable via the server. A so-called enterprise architecture assessment model is also provided to generate a maturity model map, the enterprise architecture assessment model being a structured process and system for gathering and analysing information about an organisation in order to determine the current capability of the organisation to sustain the enterprise architecture. To this end, the maturity model map is a numerically-generated diagram that constitutes a visual representation of primary capabilities relevant to creating and sustaining the enterprise architecture.

However, the above-described technologies do not address a complete life cycle: from conception to market and misjudging the level of maturity of technology with market requirements contribute to failed investment in technology. Indeed, it is over the life cycle that an enterprise has to try to bridge the well-know “valley of death” where deliverables resulting from investments in research and applied research do not directly contribute to a product in the marketplace and so the potential for return on the investment is reduced. Furthermore, the technology developed is often incompatible with other projects and so return on investment is further reduced.

According to a first aspect of the present invention, there is provided a technology enterprise management apparatus, comprising: a processing resource arranged to support a stage and gateway process having a plurality of stages and a plurality of gateways interlaced with the plurality of stages, the processing resource also supporting a plurality of stage engineering module structures respectively associated with the plurality of stages, each of the stage engineering module structures supporting, at least in part, a function associated with the stage and gateway process; and a database accessible by the processing resource and arranged to permit storage of data at least relating to the function; wherein the processing resource is arranged to monitor an assessment of the function at a stage of the stage and gateway process and to manage progression to a succeeding adjacent stage of the stage and gateway process in response to the assessment.

The processing resource may be arranged to support a data structure associated with a module class; the module class may be defined by a performance attribute, an inventory attributes and a technology attribute; and the assessment may be in respect of the module class.

The processing resource may be arranged to manage the progression of the module class to the succeeding adjacent stage of the stage and gateway process.

The progression to the succeeding adjacent stage of the stage and gateway process may relate to maturity of development of the module class.

Each of the stage engineering module structures may be a control level network.

Each of the stage engineering module structures may comprise a plurality of task modules.

A task module of the plurality of task modules may be arranged to generate at least part of the data relating to the function.

The data generated in relation to the function may be indicative of further development required in respect of the module class.

The data at least relating to the function may be indicative of a maturity mismatch between the performance attribute and the technology attribute.

The plurality of task modules may comprise a requirements task module arranged to access, when in use, performance attribute data and prioritise requirements for a proposed design configuration.

The requirements in respect of a design configuration may be prioritised using a House of Quality tool.

The plurality of task modules may comprise an intellectual capital management task module arranged to identify, when in use, rights relating to a proposed design configuration.

The plurality of task modules may comprise a Stakeholder Management task module arranged to provide, when in use, investment case information.

The plurality of task modules may comprise a solutions task module arranged, when in use to provide scientific and/or engineering information for providing a technical specification.

The plurality of task modules may comprise a critical analysis task module arranged to perform, when in use, critical analysis in respect of a proposed design configuration.

The plurality of task modules may comprise a performance assessment task module arranged to characterise, when in use, performance of a proposed design configuration.

The requirements task module may be interfaced with the intellectual capital task module and the solutions task module.

The intellectual capital task module may be interfaced with the stakeholder management task module.

The solutions task module may be interfaced with the critical analysis task module and the intellectual capital task module.

The critical analysis task module may be interfaced with the performance assessment task module and the requirements task module.

The plurality of stages may comprise a first stage arranged to employ the stage engineering module structure in order to permit scientific validation of technology associated with a proposed design configuration.

The plurality of stages may comprise a second stage arranged to employ the stage engineering module structure in order to permit verification that use of a technology may be permitted or unconstrained in respect of a proposed design configuration based upon sociological restraint data.

The plurality of stages may comprise a third stage arranged to employ the stage engineering module structure in order to permit determination as to whether a stakeholder in an organisation may be capable of supporting development of a proposed design configuration.

The plurality of stages may comprise a fourth stage arranged to employ the stage engineering module structure in order to permit determination as to whether project design resources are able to specify a solution for a proposed design configuration.

The plurality of stages may comprise a fifth stage arranged to employ the stage engineering module structure in order to permit determination as to whether an enterprise may be able to manufacture a product in accordance with a proposed design configuration.

The plurality of stages may comprise a sixth stage arranged to employ the stage engineering module structure in order to permit determination as to whether an organisation may be able to provide adequate support to a customer in respect of a proposed design configuration.

The plurality of stages may comprise a seventh stage arranged to employ the stage engineering module structure in order to permit determination as to an impact resulting from operation of a proposed design configuration in a market.

The processing resource may be arranged to support categorisation of performance attributes into module classes.

The processing resource may be arranged to support categorisation of technology attributes into module classes.

According to a second aspect of the present invention, there is provided a method of modelling a technology enterprise, the method comprising: providing a stage and gateway process having a plurality of stages and a plurality of gateways interlaced with the plurality of stages; and providing a plurality of stage engineering module structures respectively associated with the plurality of stages, each of the stage engineering module structures supporting, at least in part, a function associated with the stage and gateway process; storing data at least relating to the function; monitoring an assessment of the function at a stage of the stage and gateway process; and managing progression to a succeeding adjacent stage of the stage and gateway process in response to the assessment.

According to a third aspect of the present invention, there is provided a computer program code element comprising computer program code means to make a computer execute the method as set forth above in relation to the second aspect of the invention.

The computer program code element may be embodied on a computer readable medium.

It should be appreciated that reference herein to performance attributes relates to product attributes derived from Market Needs, Enterprise's Market Capabilities and Market Scenarios. Performance attributes do not include specifications of technology but they are expressed in engineering terms, for example, how fast, how high, how far.

It is thus possible to provide an apparatus and method that enables stewardship to be better exercised over a life cycle of a technology application being developed as well as a project. Application of a technology enterprise model by the apparatus and method provides a consistent and substantially complete definition for an enterprise software framework that is stable and therefore reusable across different markets and so can be readily configured by users for any goods and services. Areas of complexity can be more easily visualised in order to track development and disentangle complicated inter-relationships between cross-market and cross-sector organisations. A common language and a common (and consistent) framework are provided to enable a life cycle of a technology application to be managed from conception to recycling. Consequently, it is possible to make practical investment decisions relating to individual technology applications where to obtain a return on investment requires the coordination of multiple cross-market/cross-sector organisations in order to provide the technology applications. Furthermore, the apparatus and method supports development of enterprises capable of delivering innovative and newly emerging technology applications. Additionally, individual technology applications can be structured to provide high levels of functionality with shortest times to market and hence lowest risk to investment in terms of failure to succeed in the market. It is also possible to provide a consistent requirement set for an open architecture for enterprise software applications, for example where third party software providers are able to provide requirements management software and/or mathematical modelling software applications in support of solution development of the technology enterprise model, which recognises the relative maturity of information in a life cycle of a technology application.

The plurality of stage engineering module structures being implemented by the apparatus and method also constitute a set of continuous functions that flow across the stages and result in a consistent set of evidence relating to performance of tasks in control level networks in respect of stages of a life cycle. The apparatus and method enables the evidence to be accrued and evaluated at each stage of the life cycle of a technology application in order to manage risks associated with highly developed technology. Furthermore, evidence assessments provided ensure that necessary evidence is available to support a desired level of development rigour through the life cycle of development of the technology application The evidence provided by the apparatus and method can also be used to nurture new ideas, analyse problems and/or perform technology insertions within development programmes in a life cycle in order to bridge a technological gap identified, or to plan investments at the project/programme/market level.

It is also possible to balance maturity levels of different types of evidence required with respect to tasks of life cycles to deliver highly developed technology. In this respect, where a project has multiple applications associated therewith and a number of the multiple applications are at differing levels of maturity, evidence produced at respective gateways is correspondingly different. The alignment of the evidence produced to relevant stage tasks results in a balanced view of risks and opportunities in relation to provision of a highly developed technology.

At least one embodiment of the invention will now be described, by way of example only, with reference to the accompanying drawings, in which:

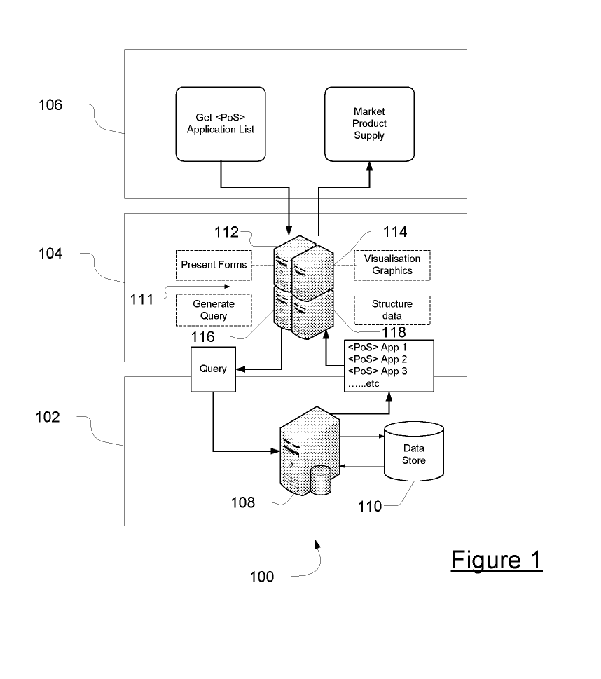

FIG. 1 is a schematic diagram of a system constituting an embodiment of the invention;

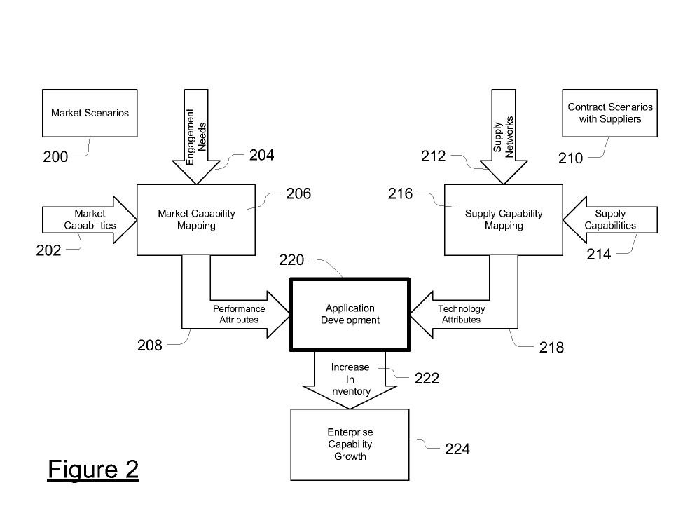

FIG. 2 is a schematic diagram of an application development model supported by the system of FIG. 1;

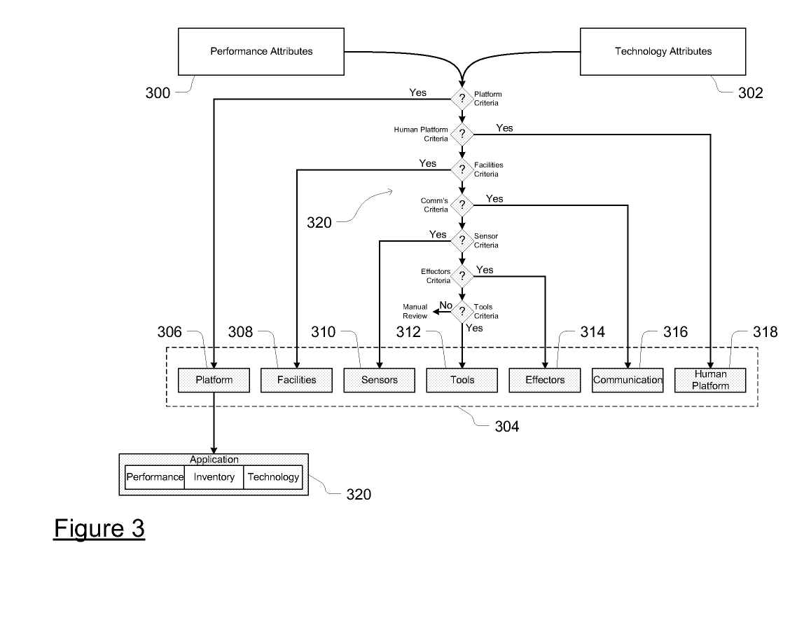

FIG. 3 is a schematic diagram of a technique for assessing attributes supported by the system of FIG. 1;

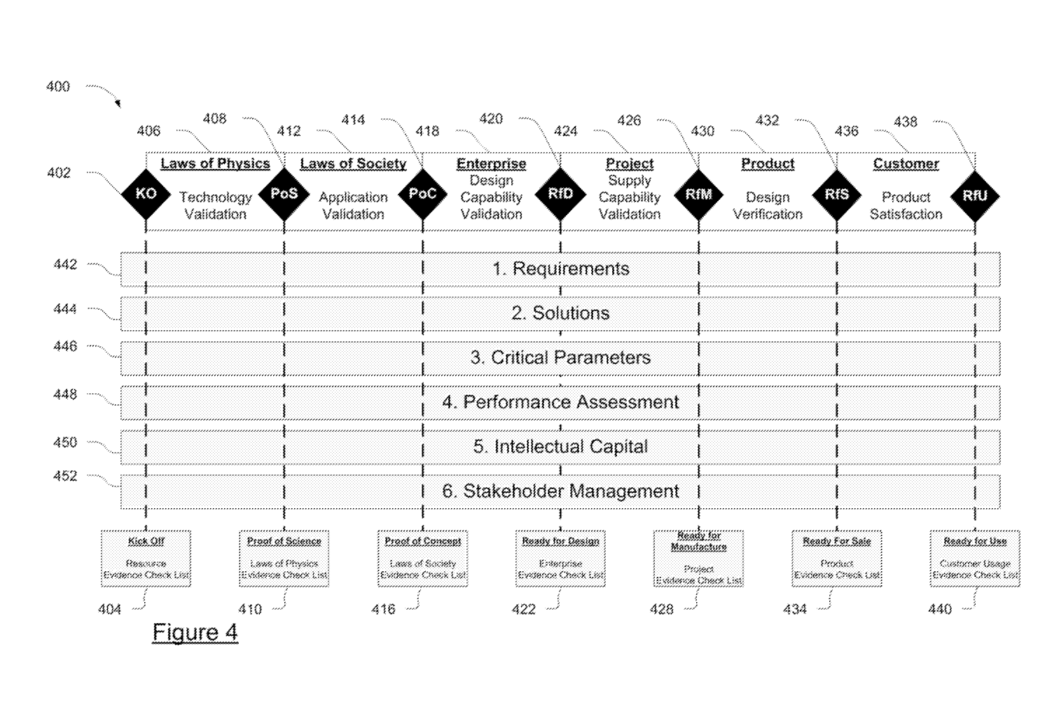

FIG. 4 is a schematic diagram of a stage and gateway process supported by the system of FIG. 1;

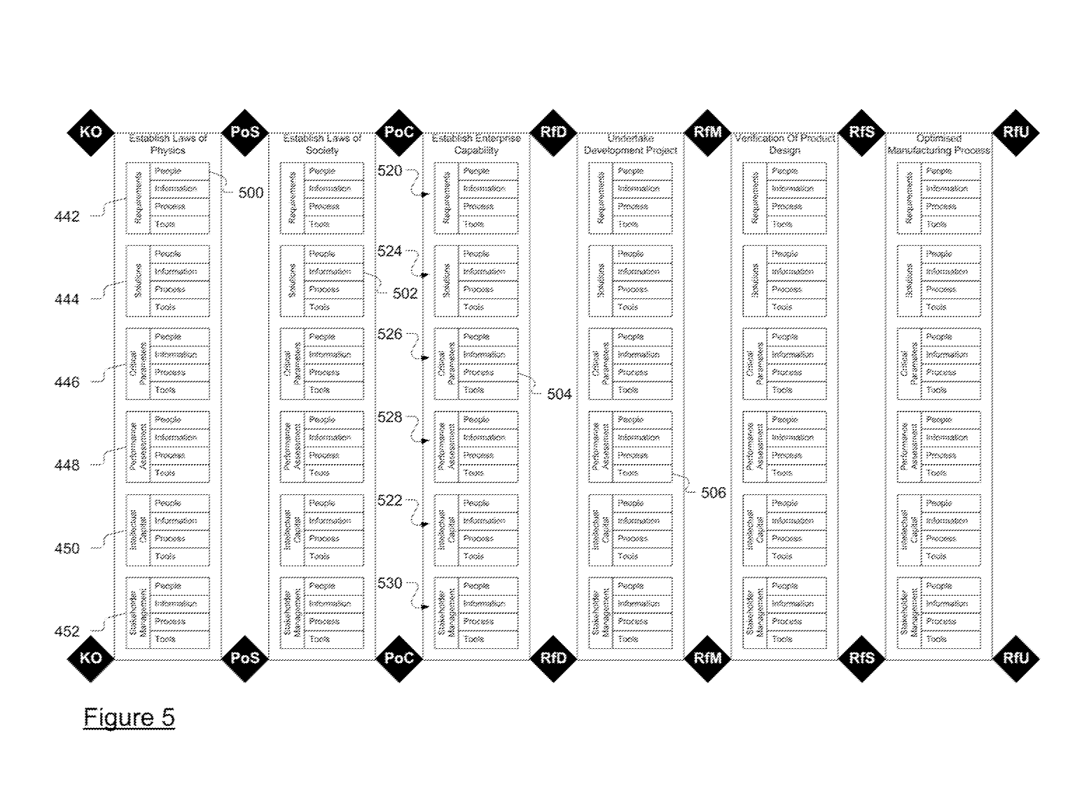

FIG. 5 is a schematic diagram of tasks and resources arranged in relation to the stage and gateway process of FIG. 4;

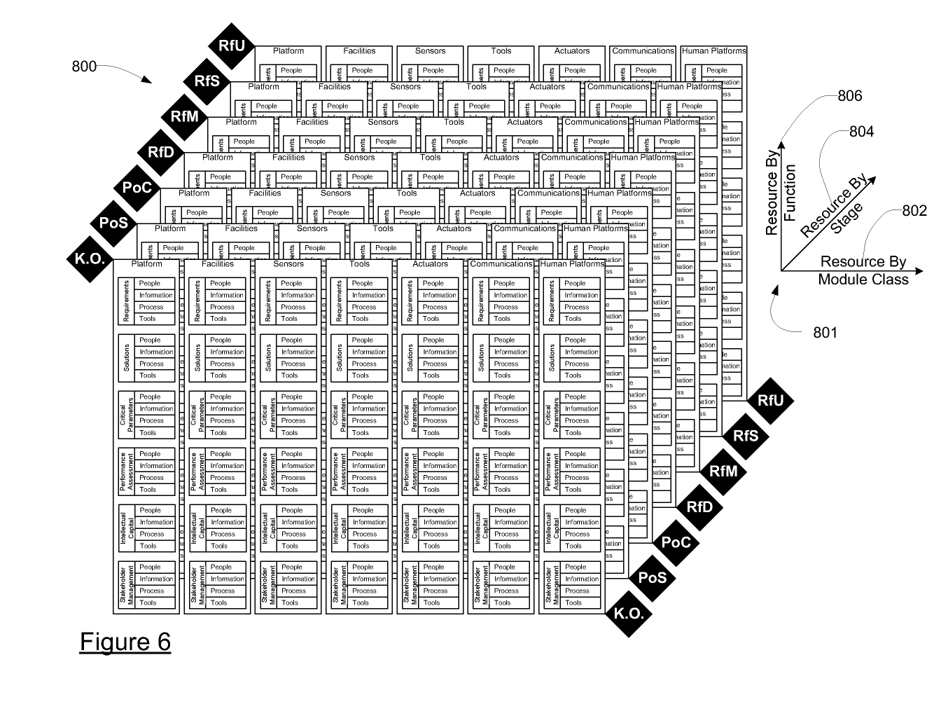

FIG. 6 is a schematic diagram of a multidimensional data structure associated with the stage and gateway process of FIG. 4;

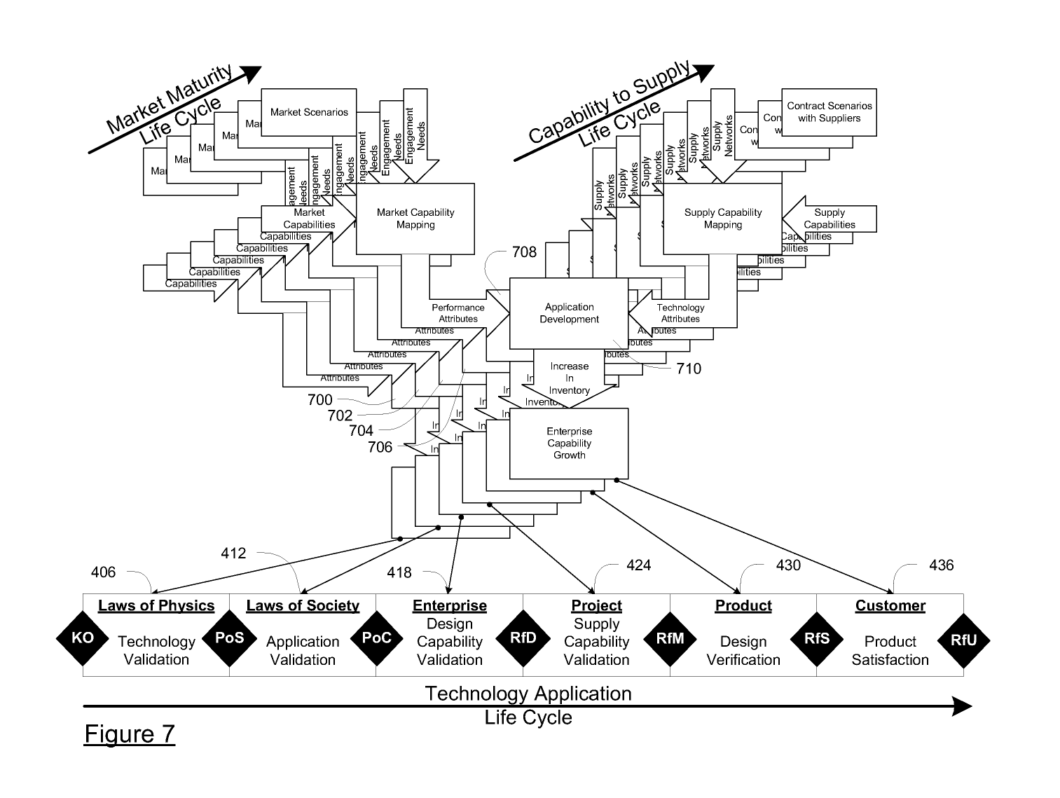

FIG. 7 is a schematic diagram of a technology application life cycle in the context of the stage and gateway methodology depicted in FIG. 4;

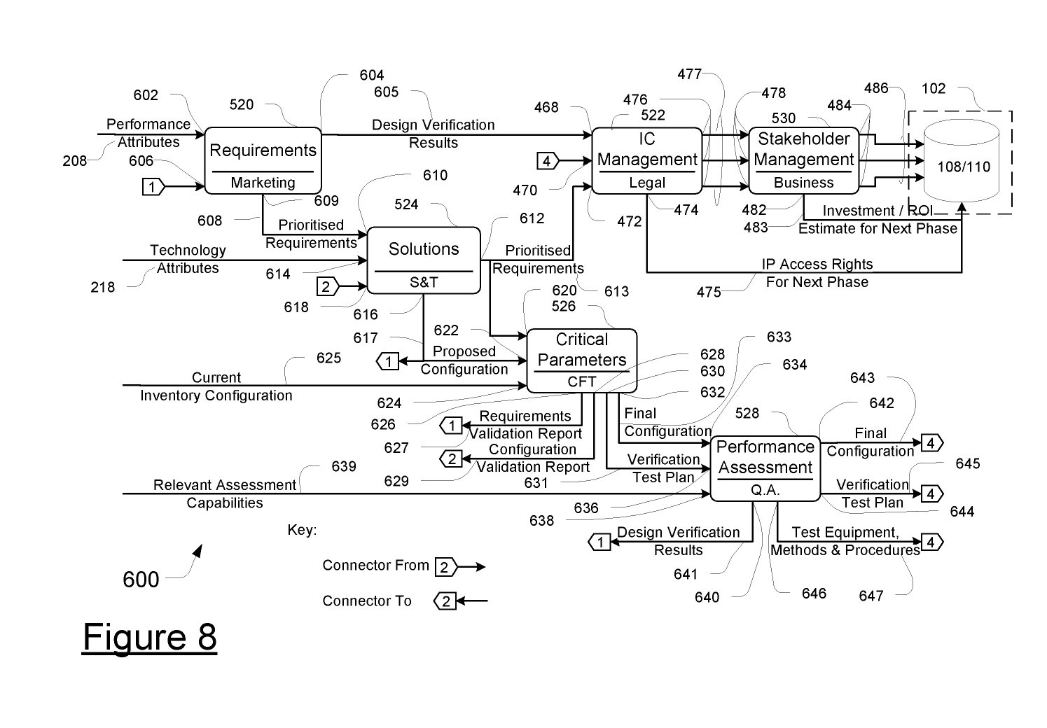

FIG. 8 is a schematic diagram of tasks associated with one or more stages of the stage and gateway process FIG. 4;

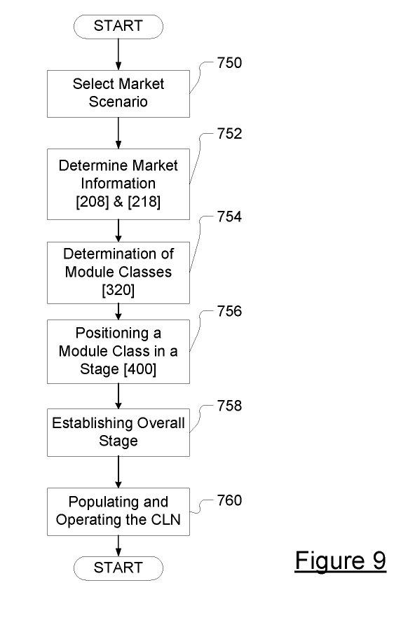

FIG. 9 is a flow diagram of a method of determining maturity levels constituting another embodiment of the invention; and

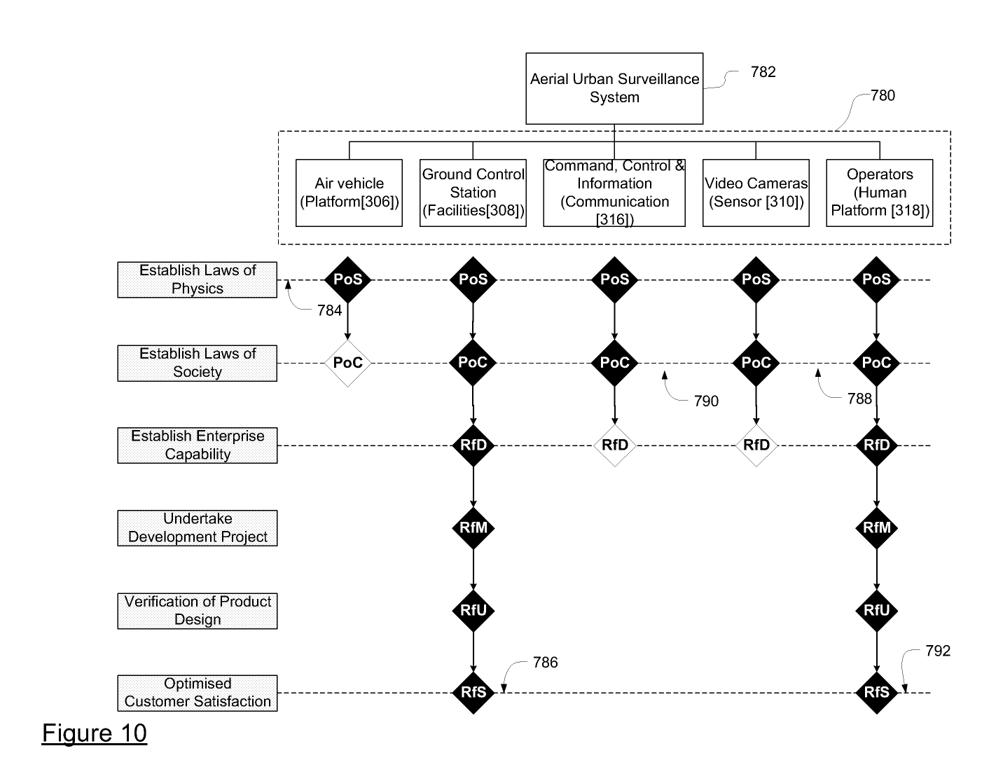

FIG. 10 is a schematic diagram of relative maturity levels of module classes.

Throughout the following description identical reference numerals will be used to identify like parts.

Referring to FIG. 1, a technology enterprise management system 100 provides a data layer 102 interfaced with a logical layer 104, the logical layer 104 being interfaced with a presentation layer 106.

The data layer 102 is supported by a database server 108 having access to a data store 110, for example a storage medium, such as a Hard Disc Drive (HDD). Although shown external to the data base server 108, the skilled person should appreciate that the data store 110 can be, and is in this example, part of the database server 108. The database server 108 is supported by any suitable hardware and runs any suitable operating system, for example a Microsoft Windows Server 2007 or a distribution of Linux, for example a suitable version of Ubuntu. A database server application, for example a relational database application, is supported by the database server 108, for example: a Structured Query Language (SQL) database, such as that available from Oracle Corporation or Microsoft Corporation. In the event that the operating system of the database server 108 is the Linux distribution as mentioned above, the database server application can be a MySQL or HSQL database server application. Although not shown in FIG. 1, the database server 108 using the data store 110 serves to store and provide access to information recorded in relation to a technology enterprise model, details of which will be described later herein. The information is stored within tables as records; the records including, in this example, one or more fields, the records being associated with a respective table created and stored in the data store 110 by the database server 108. The records are used to record and track progress of tasks being performed or to be performed by one or more organisations and/or individuals in relation to the technology enterprise model. The records are therefore organised in a manner suitable to support the technology enterprise model. Management of the structure of the records and/or inter-relationship between the records is performed in the logical layer 104.

The logical layer 104 is, in this example, supported by a cluster of inter-communicating servers 111, for example a first application server 112, a second application server 114, a third application server 116 and a fourth application server 118. However, the skilled person should appreciate that a greater or smaller number of servers can be employed, for example a single suitably powerful server. Similarly, the skilled person should appreciate that one or more of the first, second, third and fourth application servers 112, 114, 116, 118 need not be co-located. The logical layer 104, as supported by the cluster of servers 111, serves to implement the functionality of the technology enterprise model.

The first and second application servers 112, 114 of the cluster of servers 111 support the presentation layer 106. In this example, the first application server 112 is used to visually generate and therefore render visible forms, for example using a HyperText Mark-up Language (HTML) engine application (not shown). As mentioned above, the second application server 114 also supports the presentation layer 106 by providing a graphical representation of one or more aspects of the technology enterprise model, for example using a Computer Aided Design (CAD) application and/or a Computer Aided Engineering application and/or Computer Aided Manufacture (CAM), such as CATIA available from IBM®. The third application server 116 supports the data processing functionality used in relation to the technology enterprise model. In this respect, the third application server 116 is arranged to generate queries in order to mine data stored in the data store 110 and acquire data. The data captured by the third application server 116 is organised by the third application server 116 as one or more forms and/or reports that are presented by the first application server 112. The forms are pre-coded in order to support a framework of the technology enterprise model and comprise one or more code fragments in order to implement logic that supports user-interaction with the technology enterprise management system 100. The fourth application server 118 is arranged to interact with the database server 108 in order to support functionality of the technology enterprise model in relation to life-cycle management of technology applications.

As mentioned above, the presentation layer 102 is supported by the first and second application servers 112, 114. The first and second application servers 112, 114 support a Graphical User Interface (GUI) to present information content in two different manners: the first application server 112, as mentioned above, presents first information content in a first manner as forms or reports, whereas the second application server 114 presents second information content in a second manner as time-varying and/or manipulatable graphics. Through the GUI, users of the technology enterprise management system 100 can retrieve information, provide new information and/or update information. The GUI enables the users, where appropriate access privileges apply, to customise the forms, for example form and/or field titles in an organisation-specific manner and in relation to tasks of the technology enterprise model mentioned above. Similarly, forms can be completed and/or existing forms stored by the database server 108 can be maintained by users as the tasks progress or do not progress.

As mentioned above, the structure and operation of the technology enterprise model is supported by the logical layer 104. Referring to FIG. 2, the technology enterprise model supports an organisation in realising a desired performance in a market scenario 200. The market scenario 200 is a top-level description of aspects of a market engagement to be undertaken by an organisation or organisations. The market scenario 200 is proposed by the organisation or by co-operation of a number of organisations. In order to record the scenario 200 in the context of the technology enterprise model, the market scenario 200 is firstly characterised using a number of categories. The categories are, in this example, expressed in forms generated by the third application server 116 and presented by the first application server 112.

In this example, a first category is players. Information content recorded in relation to the first category is a description of people-oriented entities involved in a marketplace, for example competitors, partners, suppliers and bystanders, those entities that indirectly operate in the marketplace, such as so-called “shapers” that influence a market environment but not a given product, for example a standards body and/or a trade union. A second category is context, the context being recorded as a description of a physical environment of the market scenario 200, for example interaction with other products; physical requirements, such as temperature requirements; geospatial requirements, such as line of sight, terrestrial deployment or spatial deployment. A third category is tactics, the tactics being recorded as a description of behaviour of the first category, for example marketing practices, such as branding to promote higher prices; protection of sources of supply to reduce competition and/or reduce cost; and/or collaboration techniques that are public and/or private. A fourth category is goals, the goals being recorded as a description of objectives that the organisation wishes to achieve in the market scenario 200, for example, profit, market share and/or ethical targets. A fifth category is one or more measures of success, the measures of success being recorded as a description of metrics and/or methods of measurement to determine a degree of achievement of the fourth category, for example audits, surveys, financial criteria, environmental criteria and/or social criteria. As mentioned above, the categories are recorded in order to record a characterisation of the market scenario 200. In this respect, the forms are used to capture the characterisation of the market scenario 200 in the technology enterprise model. Reports can then be used to present the recorded information to communicate the market scenario 200 to users of the technology enterprise management system 100.

From the market scenario 200, one or more projects are devised by an analysis, for example a gap analysis, of the status of the organisation at a present point in time with respect to the market scenario 200, which is inherently predictive. Indeed, it should be appreciated that more than one market scenario can be devised and taken into account when performing the analysis in order to determine a most probable combination of parameters respectively associated with the different scenarios. One or more technology applications are then defined that are to be undertaken by the organisation in order to bring about the market scenario 200. When a market scenario requires one or more technology applications, the technology applications are sequenced and coordinated as a project.

In order to arrive at the one or more technology applications mentioned above, market capabilities 202 and market engagement needs 204 are cross-referenced and correlated 206 with the market scenario 200 to yield a set of performance attributes 208 that characterise what is required to achieve the market scenario 200. The set of performance attributes 208 is expressed in technology independent language to the extent that the detailed means of solution provision is unconstrained, for example: the aircraft will have to fly at supersonic speeds, detect other aircraft to avoid collision or be capable of earth-orbiting space flight. In addition to the considerations of the market, consideration is also given to organisation and capability to supply in relation to the market. Consequently, in relation to supply, there exists a large number of contracts, ways of contracting and suppliers, hereinafter referred to as contract scenarios 210. Whilst the contract scenarios 210 are of a different nature to the market scenario 200, there is synergy between the respective manners in which both types of information are processed. Thus, supply networks 212 and supply capabilities 214 associated with the contract scenarios 210 are cross-referenced and correlated 216 with the contract scenario 210 to yield a set of technology attributes 218 that characterise what is required to achieve the contracting scenario 210. The set of technology attributes is expressed in a language which contrains the technology options available, for example: the resulting aircraft will be a derivative of an existing type having a new propulsion system, inertial navigation system and a modified flight control system and/or fuselage, fuel system and external control surfaces will be carried over from the existing aircraft.

As suggested above, in order to realise the market scenario 200, a number of technology applications 220 typically need to be developed, each technology application 220 being characterised by a number of the performance attributes from the set of performance attributes 208 determined above and a number of technology attributes from the set of technology attributes 218 determined above. The output of each technology application 220 is characterised by augmentation in capabilities of people, new and/or improved processes, improved information quality and/or new and/or improved equipment or tools in the enterprise, and the output resulting from actual implementation of an application constitutes an increase in inventory 222 of the enterprise and hence growth 224 of the enterprise.

Referring to FIG. 3, in relation to the set of performance attributes 208, the skilled person should appreciate that an overall collection of performance attributes 300 comprises the set of performance attributes 208, which were determined above in relation to the market scenario 200. Hence, it should be understood that other market scenarios also contribute to the overall collection of performance attributes 300. Similarly, an overall collection of technology attributes 302 comprises the set of technology attributes 218, which were determined above in relation to the contract scenario 210. Hence, it should be understood that other contract scenarios also contribute to the overall collection of technology attributes 302. The overall collection of performance attributes 300 and the overall collection of technology attributes 302 can be grouped into so-called “module classes” 304 in order to improve accessibility to performance attributes and technology attributes. In this respect, each module class constitutes a building block of a project, where an instance of a module class constitutes at least part of an application 320. Seven exemplary module classes are: a Platform module class 306, a Facilities module class 308, a Sensors module class 310, a Tools module class 312, an Effectors module class 314, a Communications module class 316, and a Human Platform module class 318. However, other module classes exist and can be derived, for example: a People Performance module class, a People Health module class, a People Organisation module class, a Process Administration module class, a Process Operation module class, a Process Education module class, an Information Security module class, an Information Storage module class, an Information Communication module class, and an Information Reconstitution module class. The skilled person should appreciate that the performance attributes 300 and the technology attributes 302 mentioned herein for use by the technology enterprise model are not exhaustive and a greater or fewer number of attributes can be employed. In this respect, when configuring the technology enterprise model for a particular purpose, for example a particular business sector, the available attributes, both performance attribute-related and technology attribute-related can be classified using a plurality of decision elements 320 in order to group the available attributes into module classes appropriate to a given attribute. The module classes are stored in respective data structures associated therewith. Further details of classification of the attributes into module classes will be described later herein in the context of an exemplary project.

Referring to FIG. 4, once the set of module classes 304 have been determined, the technology enterprise model is used to implement a stage and gateway process 400 supported by the logical layer 104, constituting a processing resource. The stage and gateway process 400 comprises a plurality of stages interlaced with a plurality of gateways, the process 400 being for managing the life cycle of a first application. The stage and gateway process 400 comprises a first gateway 402. The first gateway is an initiating or “kick-off” gateway and is used to determine whether a first, resource evidence, check list 404 has been reviewed and all items on the first resource evidence check list have been provided. The first resource evidence check list is a form stored in the data store 110 by the database server 108. At the first gateway 402, the timescales are also agreed in relation development of a project.

A first stage 406 is located adjacent the first gateway 402. Whilst all the items on the first resource evidence check list do not have to be satisfied to permit processing in relation to the first stage 406, the logical layer 104 provides one or more warnings in relation to unsatisfied items on the first resource evidence check list. It should be appreciated that, in this example, the logical layer 104 polices compliance with the first, and other, resource evidence check lists. However, the skilled person should appreciate that operators of the technology enterprise management system 100 can determine whether or not progression to a subsequent stage in the stage and gateway process 400 should be permitted.

The purpose of the first stage 406 is to perform appropriate tasks in order to determine whether underlying scientific principles are known and are parameterised. The technology validation stage 406 is sometimes referred to as a “Laws of Physics” stage on the basis that all technology is considered to reduce to a matter of physics, including for example the fields of chemistry and molecular biology.

A second gateway 408 is located adjacent the first stage 406 opposite the first gateway 402. The second gateway 408 serves to provide verification as to whether the first stage 406 has been sufficiently completed, for example scientifically to validate technology associated with a proposed design configuration. The completion of the first stage 404 is measured using a second evidence check list 410 associated with the activities required in relation to the first stage 406, for example viability of the technology being developed and that no further technology needs to be developed to be able to realise a given module class and/or technology application. Whilst all the items on the second, proof of science, evidence check list 410 do not need to be satisfied for the logical layer 104 to permit progression to a second stage 412, in this example the logical layer 104 provides one or more warnings in relation to unsatisfied items of the second evidence check list 410.

The second stage 412 is located adjacent the second gateway 408. In this example, the second stage 412 is a sociological validation stage, sometimes referred to as a “Laws of Society” stage. The purpose of the second stage 412 is to perform appropriate tasks in order to establish a range of parameters required and allowed by standards, codes of practice and legislation relating to the markets mentioned above, thereby ensuring that any aspect of the given technology application and/or module class does not contravene the standards, codes of practice or legislation mentioned above, for example statutes or moral or other standards of society. A third gateway 414 is located adjacent the second stage 412 and opposite the second gateway 408. The third gateway 414 serves to provide verification as to whether the second stage 412 has been sufficiently completed, for example use of a technology is permitted or unconstrained in respect of a proposed design configuration in the light of sociological restraint data. The completion of the second stage 412 is measured using a third evidence check list 416 associated with the activities required in relation to the second stage 412, for example that the technology associated with the given technology application and/or module class does not offend any laws of society as described above. Whilst all the items on the third, proof of concept, evidence check list 416 do not need to be satisfied for the logical layer 104 to permit progression to a third stage 418, in this example the logical layer 104 provides one or more warnings in relation to unsatisfied items of the third evidence check list 416.

The third stage 418 is located adjacent the third gateway 414. In this example, the third stage 418 is a design capability validation stage. The purpose of the third stage 418 is to perform appropriate tasks in order to establish that all stakeholders, for example parties involved in end-user and manufacturing communities, have quantified resources required to perform their respective down stream roles in relation to the stage and gateway process 400. A fourth gateway 420 is located adjacent the third stage 418 and opposite the third gateway 414. The fourth gateway 420 serves to provide verification as to whether the third stage 418 has been sufficiently completed, for example to determine whether one or more stakeholders are capable of supporting development of a proposed design configuration. The completion of the third stage 418 is measured using a fourth evidence check list 422 associated with the activities required in relation to the third stage 418, for example that, as mentioned above, all stakeholders have quantified resources required to perform their respective downstream roles. Whilst all the items on the fourth, enterprise evidence, check list 422 do not need to be satisfied for the logical layer 104 to permit progression to a fourth stage 424, in this example the logical layer 104 provides one or more warnings in relation to unsatisfied items of the fourth evidence check list 420.

The fourth stage 424 is located adjacent the fourth gateway 420. In this example, the fourth stage 424 is a supply capability validation stage. The purpose of the fourth stage 424 is to perform appropriate tasks in order to manage project design resources, for example people, processes, information and tools, in order to provide solution specifications. A fifth gateway 426 is located adjacent the fourth stage 424 and opposite the fourth gateway 420. The fifth gateway 426 serves to provide verification as to whether the fourth stage 424 has been sufficiently completed, for example to determine whether project design resources are able to specify a solution for a proposed design configuration. The completion of the fourth stage 424 is measured using a fifth evidence check list 428 associated with the activities required in relation to the fourth stage 424, for example that, as mentioned above, all necessary design specifications are completed, mutually compatible and collectively capable of operating to meet prioritised requirements mentioned later herein. Whilst all the items on the fifth, project evidence, check list 428 do not need to be satisfied for the logical layer 104 to permit progression to a fifth stage 430, in this example the logical layer 104 provides one or more warnings in relation to unsatisfied items of the fifth evidence check list 428.

The fifth stage 430 is located adjacent the fifth gateway 426. In this example, the fifth stage 430 is a design verification stage. The purpose of the fifth stage 430 is to perform appropriate tasks to manage manufacturing and delivery of resources in order to get design compliant goods and/or services to a point of sale. A sixth gateway 432 is located adjacent the fifth stage 430 and opposite the fifth gateway 426. The sixth gateway 432 serves to provide verification as to whether the fifth stage 430 has been sufficiently completed, for example to determine whether an organisation is able to manufacture a product in accordance with a proposed design configuration. The completion of the fifth stage 430 is measured using a sixth evidence check list 434 associated with the activities required in relation to the fifth stage 430, for example that, as mentioned above, all necessary manufacturing and delivery resources are in place in order to ensure that the goods and/or service will reach the point of sale. Whilst all the items on the sixth, product evidence, check list 434 do not need to be satisfied for the logical layer 104 to permit progression to a sixth stage 436, in this example the logical layer 104 provides one or more warnings in relation to unsatisfied items of the sixth evidence check list 434.

The sixth stage 436 is located adjacent the sixth gateway 432. In this example, the sixth stage 436 is a product satisfaction stage. The purpose of the sixth stage 436 is to perform appropriate tasks to ensure that support is provided, for example in respect of a proposed design configuration, to customers by way of, for example, product education and warranty support. A seventh gateway 438 is located adjacent the sixth stage 436 and opposite the sixth gateway 432. The seventh gateway 438 serves to provide verification as to whether the sixth stage 436 has been sufficiently completed. The completion of the sixth stage 436 is measured using a seventh evidence check list 440 associated with the activities required in relation to the sixth stage 436, for example that, as mentioned above, all necessary support has been provided for customers. Whilst all the items on the seventh, customer usage evidence, check list 440 do not need to be satisfied for the logical layer 104 to permit progression to a seventh stage (not shown), in this example the logical layer 104 provides one or more warnings in relation to unsatisfied items of the seventh evidence check list 440.

Although not shown in FIG. 4, a seventh stage is located adjacent the seventh gateway 438. In this example, the seventh stage is a recycling stage. The purpose of the seventh stage is to perform appropriate tasks to ensure negative social and commercial impact resulting from operation of goods and/or services, for example according to a proposed design configuration, in the marketplace is minimised. An eighth gateway (also not shown) is located adjacent the seventh stage and opposite the seventh gateway 438. The eighth gateway serves to provide verification as to whether the seventh stage has been sufficiently completed. The completion of the seventh evidence stage is measured using a seventh check list (also not shown) associated with the activities required in relation to the seventh stage, for example that, as mentioned above, all necessary provisions have been made for recycling of the goods and/or services. Whilst all the items on the eighth, recycling provision evidence, check list do not need to be satisfied for the logical layer 104 to deem progression to be complete, in this example the logical layer 104 provides one or more warnings in relation to unsatisfied items of the eighth check list.

For each stage of the stage and gateway process 400, as described above, the technology enterprise management system 100 supports a respective set of tasks of the technology enterprise model, the results of which are monitored and managed by the technology enterprise management system 100 according to the technology enterprise model in the manner described above, in order to attempt to ensure completion of each stage to a required degree. In this respect, each task of the set of tasks, details of which will be described later herein, permeate through the stages of the stage and gateway process 400 and constitute a “Requirements Management” function 442, a “Solutions” function 444, a “Critical Parameters” function 446, a “Performance Assessment” function 448, an “Intellectual Capital” function 450 and a “Stakeholder Management” function 452. Each function is formed by taking an aggregate view of an instance of the same type of task from each stage across the stage and gateway process 400 for example, the requirements function 442 is comprised of the aggregate of the requirements task 520 which is undertaken at each of the first, second, third, fourth, fifth and sixth stages 406, 412, 418, 424, 430, 436.

Referring to FIG. 5, in this example, each of the above six functions 442, 444, 446, 448, 450, 452 is supported by four types of resources: People 500, Information 502, Processes 504, and Tools 506, the collection and configuration of resources for each task differing between stages of the stage and gateway process 400 for each task being performed.

In the context of the project mentioned above, and referring to FIG. 7, in this example the project comprises a number of applications, each application being defined in the manner described above. A first application 700 is at the first stage 406 of the stage and gateway process 400 and hence a first stage of a first life cycle associated with the first application 700. A second application 702 is at the second stage 412 of the stage and gateway process 400 and hence a second stage of a second life cycle associated with the second application 702. A third application 704 is at the third stage 418 of the stage and gateway process 400 and hence a third stage of a third life cycle associated with the third application 704. A fourth application 706 is at the fourth stage 424 of the stage and gateway process 400 and hence a fourth stage of a fourth life cycle associated with the fourth application 706. A fifth application 708 is at the fifth stage 430 of the stage and gateway process 400 and hence a fifth stage of a fifth life cycle associated with the fifth application 708. A sixth application 710 is at the sixth stage 436 of the stage and gateway process 400 and hence a sixth stage of a sixth life cycle associated with the sixth application 710. The skilled person should hence appreciate that a given stage in each respective lifecycle of a given application can vary depending upon the project, but that the above example of a distribution of applications at various stages of respective life cycles is provided for illustrative purposes only.

Turning to FIG. 8, in order to develop the applications and/or module classes, the stage and gateway process 400 comprises an application development process having a stage engineering module structure; the application development process constitutes a repeatable process structure to construct complex, highly developed technology applications. The application development process is repeated for each stage of the life cycle of a given application. The application development process is an organisation of the tasks mentioned above and sequenced to receive inputs and to produce outputs in a systematic and scalable manner. The application development process contains the set of tasks 520, 522, 524, 526, 528 530 mentioned above. Resources, which include the People 500, Information 502, Processes 504, and Tools 506, are applied to each of the appropriate tasks 520, 522, 524, 526, 528 to produce an output from performance of the task, the output constituting evidence of delivery of the task, irrespective of degree, each time the application development process is executed. The nature of the resources applied at each stage is determined by the purpose of each stage, for example the Laws of Physics stage 406 and the intellectual capital accessible to the enterprise via the contract scenario 210. In this example, the application development process, in particular the stage engineering module structure, is expressed as a so-called “control level network” 600 for the sake of visualisation and ease of understanding and comprises a plurality of task modules, hereinafter referred to as “tasks”.

The control level network 600 is implemented in the logical layer 104. The Requirements management function 442 is supported in the control level network 600 by a Requirements task 520 that comprises a first input 602 for performance attributes 208 and a first output 604 for design verification results, the design verification results serve as evidence for an Intellectual Capital Management task 552 that supports the Intellectual Capital function 450 mentioned above. The derivation of the design verification results will be described later herein. The Requirements task 520 is a collection of resources characterised by people, information, processes and tools, and regulated by the logical layer 104, in order to optimise the range over which a given application will operate for each attribute of the performance attributes 208. The optimisation of the range serves to further specify aspects of the performance attributes 208 in order to direct a design process. By way of example, in order to constrain design to certain staple engineering solutions, one can specify that the aircraft has to fly below a height of 3000 m, thereby avoiding certain design complexities and costs associated with aircraft that are capable of flying above 3000 m. Optimisation can involve further iterations of the cross-reference and correlation 206 derived from the market engagement needs 204, the market scenario information 200 and the market capability information 202. The Requirements task 520 also comprises a second input 606 the purpose of which will become apparent later herein and a second output 609 for providing first prioritised requirements 608 in respect of a design configuration, the first prioritised requirements 608 serving as evidence for a Solutions task 524. The requirements for the proposed design configuration can be prioritised using a so-called House of Quality tool. The Solutions task 524 supports, in part, the Solutions function 444 of the stage and gateway process 400.

The Solutions task 524 has a first input 610 for receiving the first prioritised requirements 608 and a first output 612 for providing second prioritised requirements 613 (mentioned above in relation to the fourth stage 424 of the stage and gateway process 400) to the Intellectual Capital Management task 522 and a Critical Parameters task 526 that supports, in part, the Critical Parameters function 446. The Solutions task 524 is a set of resources that are characterised by people, information, processes and tools and that relate to scientific and/or engineering techniques necessary to provide technical specifications for products. The Solutions task 524 also comprises a second input 614 for technology attributes and a second output 616 for providing proposed configuration data 617 for a design and that serve as evidence for the Critical Parameters task 526 and the Requirements task 520, the second input 606 of the Requirements task 520 serving to receive the proposed configurations information 617. The Solutions task 524 also comprises a third input 618 the purpose of which will be described later herein.

The Critical Parameters task 526 comprises a first input 620 for receiving the second prioritised requirements 613 mentioned above, a second input 622 for receiving the proposed configuration information 617 mentioned above, and a third input 624 for receiving current inventory information 625. The current inventory configuration represents those inventory items already in existence and accessible to an enterprise to which the proposed configuration must interface in order to function satisfactorily. The Critical Parameters task 526 is a set of people, information, processes and tools arranged to provide critical analysis of the proposed configuration information 617 provided by the Solutions task 524. The Critical Parameters task 526 implements any suitable critical analysis methodology, for example a parameter design methodology, a design of experiments methodology and/or a Taguchi methodology with the aim of effective partitioning of parameters to make designs insensitive to noise sources.

The Critical Parameters task 526 also has a first output 626 for providing Requirements validation report information 627 and a second output 628 for providing configuration validation report information 629. A third output 630 of the Critical Parameters task 526 is used to provide verification test plan information 631 for the design and a fourth output 632 of the Critical Parameters task 526 is used to provide final configuration information 633 for the design. The requirements validation report information 627 serves as evidence for the Requirements task 520, the requirements validation report information 627 being received by the Requirements task 520 via the second input 606 thereof. The configuration validation report information 629 serves as evidence for the Solutions task 524, the configuration validation report information 629 being received by the Solutions task 524 via the third input 618 thereof. The verification test plan information 631 and the final configuration information 633 serve as respective evidence for a Performance Assessment task 528, the Performance Assessment task 528 supporting, in part, the Performance Assessment function 448.

In overview, the Critical Parameter task 526 relates to use of, inter alia, information generated by Requirements and Solution tasks 520, 524 with the aim, as mentioned above, of effective partitioning of parameters to make designs insensitive to noise sources. The aim of the Critical Parameter task 526 is to find an effective balance between data generated by the Requirements task 520 and the Solution task 524 by growing Intellectual Capital, for example Intellectual Property relating to the solution configuration which works best in the presence of noise factors.

The Performance Assessment task 528 comprises a first input 634 for receiving the final configuration information 633 and a second input 636 for receiving the verification test plan information 631. The Performance Assessment task 528 is a set of people, information, processes and tools arranged to provide design of test methods and equipment to verify the performance of the design proposed, and as specified by the final configuration information 633 following critical parameter analysis, against the prioritised requirements 613 contained within the verification test plan 631. A third input 638 of the Performance Assessment task 528 is arranged to receive relevant assessment capability information 639. The Performance Assessment task 528 also comprises a first output 640 for providing design verification results information 641, the design verification results information 641 serving as evidence for the Requirements task 520 and is received by the second input 606 thereof. The design verification results information 641 can then be provided to the Intellectual Capital Management task 522 via the first output 604 of the Requirements task 520, the design verification results information 641 being released to the Intellectual Capital Management task 522 by the Requirements task 520 once the Requirements task 520 has correlated the design verification results information 641 with the requirements validation report information 627 obtained from the Critical Parameters task 526 mentioned above. A second output 642 of the Performance Assessment task 528 provides final configuration information 643 that serves as evidence for the Intellectual Capital Management task 522. The Performance Assessment task 528 also comprises a third output 644 for providing verification test plan information 645 that serves as evidence for the Intellectual Capital Management task 522. A fourth output 646 of the Performance Assessment task 528 provides test equipment methods and procedures information 647 that also serves as evidence for the Intellectual Capital Management task 522.

The Intellectual Capital Management task 522 comprises a first input 468 for receiving the design verification results information 605 described above. The Intellectual Capital Management task 522 is a set of people, information, processes and tools arranged to provide identification of and/or access to intellectual capital, and/or protection of intellectual capital, sometimes protected by intellectual property laws, the intellectual capital relating to delivery of a solution as verified by the Performance Assessment task 528 for the purpose of providing a competitive advantage and rights can subsist, for example, in a proposed design configuration. Intellectual Capital can be generated as a result of implementation of any of the six tasks 520, 522, 524, 526, 528, 530 described herein. As mentioned above, Intellectual Capital can be protected by law, for example but not limited to laws relating to trade marks, industrial designs, copyright and patents. A second input 470 of the Intellectual Capital Management task 522 serves to receive the final configuration information 643, the verification test plan information 645 and the test equipment, methods and procedures information 647 mentioned above. A third input 472 is arranged to receive the second prioritised requirements information 613 produced by the Solutions task 524 as mentioned above. A first output 474 of the Intellectual Capital Management task 522 provides Intellectual Capital access rights information 475 to be stored by the data layer 102 for use in a subsequent stage and evidence access in the current stage. A number of further outputs 476 are provided for a number of items of evidence 477 which comprise, for example the design verification results 605, the second prioritised requirements 613, the final configuration information 643, the verification test plan information 645 and the test equipment, methods and procedures information 647, to be communicated with a Stakeholder Management task 530, the Stakeholder Management task 530 supporting, in part, the Stakeholder Management function 452.

The Stakeholder Management task 530 comprises a number of corresponding inputs 478 and a first output 482 for providing investment estimate information 483 for an investment case to be stored by the data layer 102 for use in a subsequent stage. The Stakeholder Management task 530 is a set of people, information, processes and tools arranged to manage access to suitable Intellectual Capital for use in each stage of the life cycle for the technology application. The Stakeholder Management task 530 manages links to enterprises that own parameters and functions relating to development of a given module class and/or technology application and includes, for example, legal, financial, and human resources organisations. The Stakeholder Management task 452 also comprises a number of outputs 484 for storing a number of items of evidence 486 comprising for example, the design verification results 605, the second prioritised requirements 613, the final configuration information 643, the verification test plan information 645 and the test equipment, methods and procedures information 647 within the data layer 102.

The information structures produced by the continuous enterprise functions 442, 444, 446, 448, 450, 452 at each stage when, in this example the presentation layer 106, the logical layer 104 and the data layer 102, interact form multidimensional metadata definitions 800 (FIG. 6) for which industrial and commercial ownership and authorities are established, in this example, by the logical layer 104. The enterprise metadata structure 800 is maintained by the fourth application server 118. An operator of the technology management system 100 is able to interrogate the metadata structure 800 using forms presented by the first application server 112 via the presentation layer 106. The operator is therefore able to view resource data along a set of defined axes 801. Each axis represents a particular point of view required by an enterprise. In this example, the defined axes are resources by module class 802, resources by stage 804 and resources by function 806. An operator, responsible for the requirements function in an enterprise, might wish to know the cost of the requirements task for each stage of the stage and gateway process 400 with a view to optimising the use of resources for each requirements task at each stage to produce the most cost effective and timely provision of the overall requirements function 442. The skilled person should appreciate that the point of view can be pivoted around each axis to provide information relevant to other users of the technology enterprise management system 100. In order to support this functionality, the fourth application server 118 supports a structure data server module 118 that interrogates the database server 108 along a point of view mentioned above and aggregates resulting information 118. The aggregated results are then rendered by the second application server 114 for display by the presentation layer 106. The continuous enterprise functions allow innovations in methods of delivery of the tasks at each stage and the gateways manage the accessibility of information from one stage to the next. These concepts provide the mechanism to bridge the infamous “valley of death” where investment in R & D fails to get a suitable return on investment. The application servers 112, 114, 116, 118 and the database server 108 cooperate to enable operators to store information in the form of, for example forms, documents and checklists that constitute evidence and use the information stored by providing access thereto by relevant operators in order to participate in operation of the control level network 600. The evidence can take any suitable form for use in relation to the project and the system 100 is sufficiently flexible to permit custom recordal of evidence irrespective of form.

The above examples have been described in the context of a technology application. However, the skilled person should appreciate that the stage and gateway process 400 can be, and is in this example, applied at a greater level of granularity. Consequently, the stage and gateway process 400 is applied to module classes relating to the technology application.

In order to better understand the embodiments described above, a further example will now be described in the context of an aviation market. In particular, the example is directed to an aerial surveillance in urban areas scenario. Referring to FIG. 9, the urban surveillance scenario is therefore firstly selected (Step 750). In this respect, as described above in relation to FIG. 2, the market scenario 200 is interpreted by the operator or a group of operators in order to direct the market capability mapping 206, the market capability mapping 206 being determined by consideration of the enterprise capabilities 202 and the engagement needs 204 in order to arrive at the set of performance attributes 208. Likewise, the contracts with suppliers 210 are interpreted by the operator or groups of operators in order to direct supply capability mapping 216, the supply capability mapping 216 being determined by consideration of the supply network 212 and the supply capabilities 214 in order to arrive at the set of technology attributes 218. As mentioned previously, a large number of performance attributes and a large number of technology attributes usually exist in respect of the market scenario selected. The attributes are determined by an operator using the fourth application server 118 and classified (Step 752) in accordance with the classification process described above in relation to FIG. 3 into module classes, for example the platform module class 306, the facilities module class 308, the sensors module class 310, the tools module class 312, the actuators module class 314, the communications module class 316 and the human platform module class 318. In this example, the GUI in cooperation with the fourth application server 118 enable attributes to be presented to an operator and allow the operator to select one or more classes for classification of each attribute. The attributes, classified in accordance with the above module classes, are stored by the database server 108. An example of the platform module class 306 is shown in Table I below:

TABLE I
Platform Architecture

| Performance | | |
|---|---|---|
| Attributes | Inventory | Technology Attributes |
| Propulsion | Internal Environment | Electrical & Electronic |
| | | Engineering |
| Manoeuvrability | Platform Electronics | Software Engineering |
| Navigation | Electrical Power & | Processes and Methods |
| | Actuators | |
| Communication | Platform Interiors | Materials and Structures |
| Environmental | Mechanical Power & | Human Sciences |
| | Actuators | |
| Situational | Powertrain | Applied Engineering |
| Awareness | | Processes & Methods |
| User Performance | Structures | Energetic Materials |
| Support | | |
| Cost | | |
| Weight | | |

In the above table, it should be appreciated that an item selected from a given column does not necessarily correlate with an item in the same row in another column. Also, attribute “headings” are only set out for the sake of conciseness and clarity of description. However, the skilled person should appreciate that each heading can have a number of sub-headings associated therewith. For example, the “Powertrain” heading comprises the following sub-headings: Powerplant, Driveline, Auxiliary Drive and Fuel Storage, and Delivery. It should also be noted that the headings described above are organised so as to define a respective architecture, for example: a Performance Attributes architecture, an Inventory architecture and a Technology attributes architecture.

Once classification of the attributes has been completed, the third application server 116 queries the database server 108 in order to identify the module classes that have been “populated” as a result of the above-mentioned classification process (Step 754), the identified module classes being presented to the operator by the second application server 114. Referring to FIG. 10, the identified module classes 780 are then each processed in order to determine (Step 756) a level of maturity of each module class within the stage and gateway process 400. In this example, the platform module class 306, the facilities module class 308, the sensors module class 310, the communications module class 316 and the human platform module class 318 are employed in relation to the urban surveillance market scenario 782. Depending upon the technology application being considered, an order in which the module classes are considered for determining respective initial levels of maturity can be defined. For example, the platform module class 306 is considered first, followed by the sensors module class 310, and then the facilities module class 308, the communications module class 316 and the human platform module class 318. In order to determine respective levels of maturity, the identified module classes 306, 308, 310, 316, 318 are each, individually sequenced against the second, third, fourth, fifth, sixth and seventh checklists 410, 416, 422, 428, 434, 440 in the determined the order mentioned above.

The checklists 410, 416, 422, 428, 434, 440 each comprise questions relating to the respective functions of the stage and gateway process 400. For example, referring back to FIG. 3, the operator initially assesses the second checklist 410 associated with the laws of physics stage 406 in respect of the platforms module class 306. The second checklist 410 is, in this example, a manual set of questions. For each question, a respective record identifying any physical evidence is created, the completeness, quantity and quality of evidence produced in respect of each question being indicative of the risk to parties associated with the market scenario 200, for example engineers, managers, members of the public, investors and/or consumers. The checklists 410, 416, 422, 428, 434, 440 can be implemented in a number of ways, including one or more forms to be completed by relevant personnel and completion assessed manually and then a result of the assessment recorded in another form, machine usable or otherwise, in order to record the assessment.

In relation to the platforms module class 306, a number of sample questions are set out in Table II below.

TABLE II

| Question | | |
|---|---|---|
| number | Proof of Science Question | Function |
| 1 | Is there evidence available that | Requirements |
| | describes the fundamental scientific | |
| | observation/phenomenon upon which the | |
| | idea is based? | |
| 2 | Is there evidence of the configuration | Solutions |
| | of the technology that produces the | |
| | fundamental phenomenon? | |
| 3 | Is there evidence that the fundamental | Critical |
| | scientific laws responsible for the | Parameters |
| | phenomenon/observations are identified | |
| | and understood? | |
| 4 | Is there evidence of fundamental | Critical |
| | algorithms that describe the | Parameters |
| | interactions and interdependencies of | |
| | the technology's configuration? | |
| 5 | Is there evidence of an experimental | Performance |
| | procedure that links the fundamental | Assessment |
| | phenomenon/observation to the | |
| | scientific laws and that it has been | |
| | run at least once? | |
| 6 | Is there evidence of a list of | Performance |
| | constraints imposed by the experimental | Assessment |
| | environment? | |
| 7 | Is there evidence of an assessment | Performance |
| | being undertaken into the operational | Assessment |
| | range over which the phenomenon was | |
| | observed? | |
| 8 | Is there any evidence of patents that | Intellectual |
| | link the configuration of the | Property |
| | technology, the observed phenomenon and | |
| | the method of usage? | |
| 9 | Is there any evidence of “Know How” | Intellectual |
| | that enables experimental procedures? | Property |
| 10 | Is there evidence of potential new | Stakeholder |
| | markets being considered for the | Management |
| | exploitation of the primary function? | |
| 11 | Is there evidence of potential new | Stakeholder |
| | products or processes in existing | Management |
| | markets? | |
| 12 | Is there evidence of potential | Stakeholder |
| | enhancements to existing products or | Management |
| | processes? | |

As mentioned above, the questions of Table II relate to the functions of the stage and gateway process 400 in respect of the laws of physics stage 406. As can be seen in table II above, for each question an associated function is identified.

As mentioned above, the evidence collected is assessed at the proof of science gateway 408 in order to determine whether the evidence accessible is sufficiently complete and of sufficient quality as defined by those personnel associated with the proof of science gateway 408. If the evidence is deemed of sufficient quality and sufficiently complete, no further work is required in relation to the collection of evidence for the laws of physics stage 406 and the process of evidence collection in relation to the platform module class can be repeated in relation to the laws of society stage 412. In this respect, different questions are employed in order to collect the evidence, which can include generation of new evidence, in order to assess whether further development work needs to be performed in relation to the laws of society stage 412. In the present example, the assessment at the proof of concept gateway 414 determines that development work in relation to the laws of society stage 412 is incomplete and so the level of maturity mentioned above in relation to the platforms module class 306 has been determined (Step 756). When assessing the platforms module class 306 in order to determine the level of maturity of the platforms module class 306, considerations associated with generation of the engagement needs 204 and the enterprise capabilities 202 are also used to guide assessment of the platform module class 306 (and other module classes). For example, in relation to the engagement needs 204, the enterprise engaging the market scenario 200 considers, inter alia, that whilst use of helicopter platforms for performance of aerial surveillance is effective and popular, the helicopter platform has an unattractive cost associated with use thereof. Consequently, it is desirable to avoid use of the helicopter platform for future performance of aerial surveillance. Hence, when assessing the platforms module class 306, the operator or operators reach a conclusion that an Uninhabited Aerial Vehicle (UAV) platform is preferred due to the above-mentioned considerations. Of course, the skilled person should appreciate that other considerations can also guide the assessment of the platforms and other module classes.

Furthermore, once the UAV platform has been identified, it is necessary, as part of the assessment in relation to the laws of society stage 412 to consider rules and regulations for flying, for example as contained in a so-called “Air Navigation Order” established by parliamentary statute in the United Kingdom (assuming the application relates to aerial surveillance in the UK). Reference to the Air Navigation Order or parts thereof can be made or quotations taken therefrom, for example, as evidence required in relation to the assessment of the platform (and other) module classes, such as Article 98(2) of the Air Navigation Order. By way of example, the UAV platform can be constrained by weight and height requirements of Article 98(2) of the Air Navigation Order. In this example, the operator or operators determine that the weight of the platforms module class 306 in combination with the sensor module class 308 and the communications module class 316 should not exceed 7 kg (excluding fuel).

For completeness, sample questions relating to the collection of evidence in relation to the laws of society stage 412 are set out below in Table III.

TABLE III

| Question | | |
|---|---|---|
| number | Proof of Concept Question | Function |
| 1 | Is there evidence of a demonstrator's | Requirements |
| | function which shows how the benefits | |
| | might be achieved in a real world | |
| | scenario? | |
| 2 | Is there evidence of a demonstrator's | Solutions |
| | technology configuration that produced | |
| | the benefit? | |
| 3 | Is there evidence to show that the laws | Critical |
| | of society that influence exploitation | Parameters |
| | have been identified and a compliance | |
| | plan defined? | |
| 4 | Is there evidence that existing | Critical |
| | interfaces that influence the new | Parameters |
| | application's function have been | |
| | identified and a compliance plan | |
| | outlined? | |
| 5 | Is there evidence of a procedure that | Performance |
| | links the functions observed from the | Assessment |
| | demonstrator to the rules/regulations/ | |
| | interfaces within society, and that the | |
| | procedure has been run successfully? | |
| 6 | Is there evidence of a list of | Performance |
| | constraints imposed or overlooked in | Assessment |
| | the evaluation environment that | |
| | influence confidence in the | |
| | demonstrator results? | |
| 7 | Is there evidence that the usage | Performance |
| | profile has been updated as a result of | Assessment |
| | the Concept demonstrator performance | |
| | assessment phase and that it still | |
| | maintains stakeholder involvement? | |
| 8 | Is there any evidence of existing legal | Intellectual |
| | instruments that affect the interfaces | Property |
| | upon which the technology depends for | |
| | correct operation in the real world | |
| | application? | |
| 9 | Is there evidence that the necessary | Intellectual |
| | “Know How” required to optimise the | Property |
| | technology interfaces exists within the | |
| | outline stakeholder group? | |
| 10 | Is there evidence of an inclusive | Stakeholder |
| | Exploiter stakeholder group that has | Management |
| | members who can potentially manage the | |
| | route to market? | |
| 11 | Is there evidence of an inclusive | Stakeholder |
| | Provider stakeholder group that has | Management |
| | members who can potentially manage the | |
| | supply of the physical product? | |
| 12 | Is there evidence of an inclusive | Stakeholder |
| | Investor stakeholder group that has | Management |
| | members who can potentially fund the | |
| | product and market development cost? | |
| 13 | Is there evidence that a Competitor | Stakeholder |
| | capability assessment has been | Management |
| | undertaken to track alternative | |
| | approaches that may cause the function | |
| | and means of provision to be less | |
| | appealing to customers and investors? | |

In a like manner to that described above in relation to the laws of physics stage 406, the questions of Table III relate to the functions of the stage and gateway process 400 in respect of the laws of society stage 406. In this respect, as can be seen in Table III above, for each question an associated function is identified.

For the sake of completeness, sample questions and associated functions relating to the collection of evidence in relation to the design capability validation stage 418, the supply capability validation stage 424 and the design verification stage 430 are set out below in Tables IV, V and VI, respectively.

TABLE IV

| Question | | |
|---|---|---|
| number | Ready for Design Question | Function |
| 1 | Is there evidence of an outline design | Requirements |
| | functionality expressed in terms of the | |
| | benefit to each stakeholder involved in | |
| | taking the design to commercial success? | |
| 2 | Is there Evidence of an outline | Solutions |
| | design's Form, Fit and Function | |
| | (technology function) of each | |
| | technology item in the design proposal? | |
| 3 | Is there evidence that the primary | Critical |
| | inputs and outputs of the design have | Parameters |
| | been correctly identified? | |
| 4 | Is there evidence that the control | Critical |
| | parameters for the design have been | Parameters |
| | identified and correctly configured? | |
| 5 | Is there evidence that the sources of | Performance |
| | noise have been identified? | Assessment |
| 6 | Is there evidence that the by | Performance |
| | products/secondary outputs have been | Assessment |
| | identified and constrained? | |
| 7 | Is there evidence of a validation | Performance |
| | procedure that links the functions | Assessment |
| | required by the design stakeholders to | |
| | the design critical parameters and | |
| | that it has been run successfully at | |
| | least once? | |
| 8 | Is there Evidence of a list of | Intellectual |
| | constraints imposed by the design | Property |
| | environment that limits the scope of | |
| | the product functionality? | |
| 9 | Is there evidence that the usage | Intellectual |
| | profile has been updated as a result of | Property |
| | the design performance assessment phase | |
| | and that it still has stakeholder | |
| | commitment? | |
| 10 | Is there evidence that the Enterprise | Stakeholder |
| | Stakeholder Group is aware of all | Management |
| | existing and new legal instruments | |
| | required for successful exploitation? | |
| 11 | Is there evidence that the necessary | Stakeholder |
| | “Know How” required for delivery | Management |
| | exists in the right places within the | |
| | stakeholder group? | |
| 12 | Is there evidence that an exclusive | Stakeholder |
| | Enterprise stakeholder group has been | Management |
| | formed? | |
| 13 | Is there evidence that the Exploiter | Stakeholder |
| | stakeholder group has outlined mutually | Management |
| | acceptable commercial terms? | |
| 14 | Is there evidence that the Provider | Stakeholder |
| | Groups have agreed mutually compatible | Management |
| | roles and responsibilities? | |

TABLE V

| Question | | |
|---|---|---|
| number | Ready for Manufacture Question | Function |
| 1 | Is there Evidence of agreement on the | Requirements |
| | Optimised functionality required from | |
| | each of the provider stakeholder groups? | |
| 2 | Is there evidence of agreement on the | Solutions |
| | final specifications of the product's | |
| | Form, Fit and Function? | |
| 3 | Is there evidence that the logistics of | Critical |
| | supply and distribution have been | Parameters |
| | identified? | |
| 4 | Is there evidence that the manufacturing | Critical |
| | process control parameters have been | Parameters |
| | correlated with the design control | |
| | parameters? | |
| 5 | Is there evidence that the processes | Performance |
| | for after sales service and | Assessment |
| | installation have been defined? | |
| 6 | Is there evidence of a product | Performance |
| | verification procedure that links the | Assessment |
| | product requirements to the product's | |
| | critical parameters and that it has | |
| | been run at least once? | |
| 7 | Is there evidence of a list of | Performance |
| | constraints imposed by the Project | Assessment |
| | environment that limits the performance | |
| | of the product functionality? | |
| 8 | Is there evidence that the usage | Intellectual |
| | profile has been updated as a result of | Property |
| | the verification procedure/project | |
| | constraints, and that it still has the | |
| | contractual commitment of the | |
| | stakeholders? | |
| 9 | Is there evidence that the Provider | Intellectual |
| | stakeholder group each has their legal | Property |
| | instruments in place to protect their | |
| | design and manufacture capability? | |
| 10 | Is there evidence that the necessary | Stakeholder |
| | “Know How” required for manufacture | Management |
| | exists in the right places within the | |
| | stakeholder group? | |
| 11 | Is there evidence that the market is | Stakeholder |
| | sufficiently developed for the product | Management |
| | to achieve the necessary sales volume? | |
| 12 | Is there evidence from the Provider | Stakeholder |
| | stakeholder group that the targets of | Management |
| | Quality, Cost and Timing will be met? | |
| 13 | Is there evidence that the Investor | Stakeholder |
| | stakeholder group has made available | Management |
| | sufficient funds to cover manufacturing | |
| | costs? | |

TABLE VI

| Question | | |
|---|---|---|
| number | Ready for Sale Question | Function |
| 1 | Is there evidence of agreement on the | Requirements |
| | optimised functionality required from | |
| | the exploiter stakeholder group? | |
| 2 | Is there evidence of agreement on the | Solutions |
| | Technology Form, Fit and Function when | |
| | measured in the actual real world usage | |
| | profile? | |
| 3 | Is there evidence that the product | Critical |
| | placement campaign has been successful? | Parameters |
| 4 | Is there evidence that the Value | Critical |
| | proposition has been optimised for the | Parameters |
| | exploiters? | |
| 5 | Is there evidence that the pricing/ | Performance |
| | feature functionality is optimised? | Assessment |
| 6 | Is there evidence that a business model | Performance |
| | verification procedure exist that links | Assessment |
| | the launch requirements to the market | |
| | critical parameters, and that it has | |
| | been run successfully at least once? | |
| 7 | Is there evidence of a list of Market | Performance |
| | constraints that influences the | Assessment |
| | exploiters' return on investments? | |
| 8 | Is there evidence that the usage | Intellectual |
| | profile has been updated as a result of | Property |
| | the Market performance assessment phase | |
| | and that it meets or exceeds stakeholder | |
| | expectations? | |
| 9 | Is there evidence that the Exploiter | Intellectual |
| | stakeholder group each has their legal | Property |
| | instruments in place to protect their | |
| | market position? | |
| 10 | Is there evidence that the necessary | Stakeholder |
| | “Know How” required for market launch | Management |
| | exists in the right places within the | |
| | stakeholder group? | |
| 11 | Is there evidence that the Exploiter | Stakeholder |
| | stakeholder group has implemented the | Management |
| | product pricing/volume plan? | |
| 12 | Is there evidence that the Provider | Stakeholder |
| | stakeholder group has met the Quality, | Management |
| | Cost and Timing targets? | |
| 13 | Is there evidence that the Investor | Stakeholder |
| | stakeholder group will achieve the | Management |
| | anticipate return on investment? | |

As mentioned above, after collecting and assessing evidence in respect of the platforms module class 306, the assessment associated with the proof of concept gateway 414 results in a determination that further development work is required in relation to the evidence collection in respect of the laws of society stage 412. Hence, the initial level of maturity of the platforms module class 306 has been determined.

Determination of the level of maturity has, of course, required the sample questions set out above. Furthermore, as mentioned above, each sample question has an associated function of the stage and gateway process 400 associated therewith. As also mentioned above, the control level network 600 is implemented in relation to each stage of the stage and gateway process 400 in order to process the sample questions and try to collect evidence associated with each question.

Referring back to FIG. 8 and in the context of the set of questions associated with the laws of physics stage 406, the Requirements task 520 comprises people, information, processes and tools that would have generated the evidence necessary in order to process the sample questions relating to the Requirements task 520, for example Unified Modelling Language (UML) techniques including class diagrams, communication diagrams and use case diagrams. For the purpose of assessment of the questions in order to determine the initial stage of maturity of the module class, the assessment of the evidence in relation to the question associated with the Requirements task 520 is performed by the above-mentioned operator or operators.

In relation to the Solutions task 524, the Solutions task 524 comprises people, information, processes and tools that are used to process the sample questions relating to the Solutions task 524, for example through Computer Aided Engineering or Computer Aided Design software applications, which include Simulink® and AutoCAD®. In relation to the Critical Parameters task 526, the Critical Parameters task 526 comprises people, information, processes and tools that are used to process the sample questions relating to the Critical Parameters task 526, for example a Taguchi methodology. In relation to the Performance Assessment task 528, the Performance Assessment task 528 comprises people, information, processes and tools that are used to process the sample questions relating to the Performance Assessment task 528, for example through usability testing, statistical control and/or reliability testing. In relation to the Intellectual Capital Management task 522, the Intellectual Capital Management task 522 comprises people, information, processes and tools that are used to process the sample questions relating to the Intellectual Capital Management task 522, for example asset registers, knowledge management techniques, brand development, patents and trademarks records databases. In relation to the Stakeholder Management task 530, the Stakeholder Management task 530 comprises people, information, processes and tools that are used to process the sample questions relating to the Stakeholder Management task 530, for example using Client Relationship Management (CRM) software applications, Prince 2® project management methods and/or so-called Influence Network techniques.

The above-mentioned assessment that takes place in respect of the proof of science gateway 408 is performed by access to the database server 108 at the data layer 102. Of course, as mentioned above, the above control level network 600 is provided in respect of each stage of the stage and gateway process 400. However, the skilled person should appreciate that processing in respect of each task in a relevant control level network 600 of a given stage is in relation to the sample questions associated with the given stage. In this respect, the people, processes, information and tools differ from stage-to-stage.

The skilled person should appreciate that once assessment in respect of the platforms module class 306 has been performed, the above-mentioned procedure is followed in respect of, the sensors module class 310, the facilities module class 308, the communications module class 316 and the human platform module class 318 in order to ascertain initial levels of maturity for each of the module classes 308, 310, 316, 318, respectively. In this respect, it should be noted that the questions used to assess the level of maturity differ for different module classes and that the example questions provided above in relation to the platforms module class 306 are provided by way of example only.

Referring to FIG. 10, in the present example, the platforms module class 306, as mentioned above, is assessed as requiring no further work in respect of the laws of physics stage 406, but that development work in relation to the laws of society stage 412 is incomplete and so the level of maturity 784 mentioned above in relation to the platforms module class 306 has been determined (Step 756). As also mentioned above, an order exists in relation to assessment of the module classes and so after assessing the platforms module class 306, it is necessary to assess the sensors module class 310.

In relation to the platforms module class 306, it was determined that the combined weight (excluding fuel) of the platforms module class 306, the sensors module class 310 and the communications module class 312 should not exceed 7 kg. Consequently, in relation to the sensors module class 310, the above assessment is guided by, inter alia, the above weight constraint. In this respect, known sensors of adequate resolution performance can weigh up to 40 kg. Whilst this weight may be acceptable where the helicopter platform is employed, such weights are incompatible with the use of the UAV platform as determined above. Therefore, as part of the assessment in relation to the sensors module class 310, a number of alternative technology solutions in respect of sensors are identified as potential candidates for use. However, the use of the candidate sensors has not necessarily been proven in combination with the UAV platform selected. For example, vibration considerations associated with flight of the UAV platform may be incompatible with one or more of the candidate sensors identified. Consequently, whilst the overall assessment of the sensors module class 310 results in a determination that no further work in respect of the laws of society stage 412 is required, development work in relation to the design capability validation stage 418 is deemed incomplete and so the level of maturity 788 mentioned above in relation to the sensors module class 310 has been determined (Step 756). In relation to the facilities module class 308, the above assessment results in a determination that no further work in respect of the product satisfaction stage 436 is required and so the level of maturity 786 of the facilities module class 308 has been determined (Step 756).

In relation to the communication module class 316, the above assessment results in a determination that no further work in respect of the laws of society stage 412 is required, but that development work in relation to the design capability validation stage 418 is incomplete and so the level of maturity 790 mentioned above in relation to the communication module class 316 has been determined (Step 756). In relation to the human platform module class 318, the above assessment results in a determination that no further work in respect of the product satisfaction stage 436 is required and so the level of maturity 792 in relation to the human platform module class 318 has been determined (Step 756).

Whilst sample questions have been provided in the above example in relation to collection of evidence for the various stages of the stage and gateway process 400, the skilled person should appreciate that the questions can be varied to suit particular implementations.

Once the initial levels of maturity have been determined for each module class as described above, it is necessary to determine (Step 758), for overview purposes, an overall stage of the project. In this example, the overall stage of the project is determined by selection of the least mature module class of the project. However, in other embodiments, the overall stage of the project can be determined by identifying a module class that is likely to consume a largest amount of resources (people, information, process and tools) and present a greatest risk of failure to enable market use. In the above example, the least mature module class and the module class likely to consume the largest amount of resource and represent the greatest risk of failure to enable market use coincide, namely the platforms module class 306.

The overall level of maturity is used by “management” to monitor overall progress of the project and to sequence resources in order to ensure that the module classes being developed for the project are progressed in such a way that the overall level of maturity of the project reaches the product satisfaction stage 436 and satisfies an assessment in respect of the ready for use gateway 438 at a desired point in time to meet market demand. In this respect, the data acquired in relation to the above described functions is used to determine maturity mismatch between module classes so that such mismatch can be obviated or at least mitigated.

To this end, once the initial levels of maturity have been determined for each module class, in respect of each of the module classes the control level network 600 is implemented (Step 760) for each stage that requires further development in order to progress maturity. The control level network 600 is also implemented in respect of the project and, in particular, in respect of the next stage in the stage and gateway process 400 that succeeds the overall level of maturity of the project.

When the control level network 600 is implemented for the project and each module class, the enterprise deploys people, processes, information and tools to perform each task, for example to implement a use case analysis in order to interpret the performance attributes 208 in combination with any proposed configuration 617 in order to produce the first prioritised requirements 608. Similarly, the enterprise deploys people, processes, information and tools to perform the Solutions task 524, for example to implement a Simulink® model for the dynamics of flight in order to interpret any of the first prioritised requirements 608, the technology attributes 218, any configuration validation report data 629 and any proposed configuration data 617 in order to produce the second prioritised requirements 613. The enterprise likewise deploys people, processes, information and tools to perform the Critical Parameters task 526, for example to implement a Taguchi methodology in order to interpret any second prioritised requirements 613, any proposed configuration 617, and any current inventory items 625 in order to produce the requirements validation data 627, the configuration validation report data 629, the final configuration data 633 and the verification test plan data 631.

The enterprise also deploys people, processes, information and tools to perform the Performance Assessment task 528, for example to implement a usability test in order to interpret any final configuration data 633, any verification test plan data 631, and any assessment capabilities data 639 in order to produce the design verification results data 641, the test equipment methods and procedures data 647, the verification test plan data 645 and the final configuration data 643.

The enterprise further deploys people, processes, information and tools to perform the Intellectual Capital Management task 522, for example to implement patent searches in order to interpret any design verification results data 605, final configuration data 643, verification test plan data 645, test equipment methods and procedures data 647 and any second prioritised requirements data 613 in order to produce the Intellectual Capital access rights data 475 and to provide the Stakeholder Management task 530 with the evidence items 605, 643, 643, 647 and 613.

Additionally, the enterprise deploys people, processes, information and tools to perform the Stakeholder Management task 530, for example to implement a ‘value added’ calculation in order to interpret the evidence items 477 in order to produce the investment/ROI estimate data 583 and to communicate the evidence items 486 to the database server 108 of the data layer 102.

As a result of performance of the above-mentioned tasks, the application servers 112, 114, 116, 118 in combination with the database server 108 store the evidence generated by each task of the control level network 600 in the data store 110. The evidence can be forms that are completed by relevant personnel, including machine-usable forms generated by the first application server 112 so as to capture data that can be subsequently used by the fourth application server 118 when assessing maturity and development of the module class and controlling progression through the stage and gateway process 400, i.e. gatekeeping.

In respect of operation of the control level network 600, the skilled person will appreciate that each task has a quality of event criteria associated therewith and a respective authority. Whilst each task can be initiated at an arbitrary time relative to the other tasks, the authority is likely to defer commencement of a given task if insufficient information or quality of information is available in relation to performance of the task associated with the authority. The respective qualities of event criteria are used to determine when a given task has been completed to a satisfactory standard for one of the other tasks downstream of the task, associated with the quality of event criteria, to be initiated. Ideally, but not essentially, the Requirements task 520, the Solutions task 524, the Critical Parameters task 526 and the Performance Assessments task 528 are executed prior to execution of the Intellectual Capital Management task 522 and the Stakeholder Management task 530.

For a given module class, the questions associated with a gateway are assessed at pre-defined points in time by the relevant operator or operators, the pre-defined points in time being set at the kick off gateway 502. Consequently, upon assessment of the questions mentioned above associated with the gateway, the assessment can result in sufficient evidence, both quantitatively and qualitatively, being available to approve passage of the module class to subsequent stage following the gateway. Similarly, the assessment may result in a determination that a proportion of the evidence required is not yet available or of insufficient quality, but that the deficiency is not critical and the module class is allowed to progress to the subsequent stage in the stage and gateway process 400 whilst further work, for example development work, is being carried out in respect of certain inadequate evidence in order to attain the desired quality and quantity thereof. Should the quality and/or quantity of the evidence available in respect of the questions associated with the gateway be deemed inadequate, the relevant operator or operators can set a subsequent point in time to re-assess the questions in respect of the gateway. Assessment results are recorded, in this example, using pre-prepared electronic forms. However, the skilled person should appreciate that the assessment results can be captured by the database server 108 by automated generation of forms to capture assessment data. Consequently, management of progression of module classes through respective instantiations of the stage and gateway process 400 can be performed by the system 100.

If desired, the fourth application server 118 can be arranged to identify failed assessments or overdue assessments. Additionally or alternatively, the fourth application server 118 can be arranged to notify the relevant operator or operators that an assessment needs to be performed.

In the context of the platforms module class 306 described above in relation to the UAV platform, a predetermined point in time is set at the kick-off gateway 402 for assessment of evidence generated by the control level network 600 in respect of the laws of society stage 412 as assessment of the initial level of maturity 784 has identified that further development work is required in respect of the laws of society stage 412. Consequently, the control level network 600 in respect of the laws of society stage 412 is executed (Step 760) and evidence is generated that is assessed in the manner mentioned above in the context of the questions for assessing evidence at the laws of society stage 412 for the platforms module class 306. Where the evidence is of insufficient quantity and/or quality, progression to the design capability validation stage 418 is managed in the manner described previously, otherwise if the evidence generated by the laws of society stage 412 is deemed by the operator or operators at the predetermined time set to be sufficient, the platforms module class 306 is progressed to the design capability validation stage 418. In a like manner, progression of the platforms module class 306 to the supply capability validation stage 424, then to the design verification stage 430 and then to the product satisfaction stage 436, is managed with respect to assessments of respective questions at the respective gateways 420, 426, 432, 438, the necessary evidence having been generated by operation of the respective control level network 600 at the stage to be assessed. The respective points in time when assessments are to be made are determined at the kick-off gateway 402.

The above process is repeated in respect of each module class having a respective stage in respect of which further development work is required. As the skilled person will appreciate, each module class therefore progresses through the stage and gateway process 400, progressing the overall level of maturity of the project, until the overall level of maturity of the project reaches the product satisfaction stage 436 at, or hopefully at, the predetermined point in time mentioned above.

Satisfactory completion of the ready for use assessment check list 440 leads to the aerial surveillance system 782 being used in a seventh stage referred to earlier as the recycling stage but not shown or referenced in any of the figures or tables. The recycling stage is similar to, and can be identical to, the product satisfaction stage 436, but the evidence used for the tasks of the product satisfaction stage 436 is replaced with evidence extracted in the context of “real world” experience rather than evidence generated in the context of the predicted market scenario 200. The eighth gateway checklist (not shown), known as a ready for re-engineering gateway checklist or a ready for recycling gateway checklist, is therefore an assessment of differences between evidence generated as a result of planning activities, which took place during one or more preceding stages of the stage and gateway process 400, and evidence that emerges from actual implementation of the application. In this respect, by examining alignment between evidence forecast during preceding stages and empirical evidence from use, it is possible to identify areas of design requiring refinement. Negative and positive implications of assessment of the re-engineering gateway checklist can be used to justify repetition of the analysis associated with one or more stages of the stage and gateway process 400 with a view to removing, modifying or inserting new resources to optimise further the performance of the product or service in the market scenario, for example in the light of a superior product introduced into the marketplace by a competitor. A skilled person should appreciate that the availability of well structured and accessible historical evidence from each of the stages from the first application life cycle greatly facilitates quality, cost and timing of upgrades for products in subsequent iterations of the application life cycle.

Although reference has been made herein to an operator of a technology enterprise management system 100, the skilled person should appreciate that any number of individuals, possibly distributed over a number of organisations, may perform the functions of the operator as described herein. Furthermore, it should be appreciated that a module class can be re-used in respect of the different projects.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

What is claims is:

1. A technology enterprise management apparatus, comprising:
a processing resource arranged to support a stage and gateway process having a plurality of stages and a plurality of gateways interlaced with the plurality of stages, the processing resource also supporting a plurality of stage engineering module structures respectively associated with the plurality of stages, each of the stage engineering module structures supporting, at least in part, a function associated with the stage and gateway process; and
a database accessible by the processing resource and arranged to permit storage of data at least relating to the function; wherein
the processing resource is arranged to monitor an assessment of the function at a stage of the stage and gateway process and to manage progression to a succeeding adjacent stage of the stage and gateway process in response to the assessment.

2. An apparatus as claimed in claim 1, wherein
the processing resource is arranged to support a data structure associated with a module class, the module class being defined by a performance attribute, an inventory attributes and a technology attribute; and
the assessment is in respect of the module class.

3. An apparatus as claimed in claim 2, wherein the processing resource is arranged to manage the progression of the module class to the succeeding adjacent stage of the stage and gateway process, the progression to the succeeding adjacent stage of the stage and gateway process relating to maturity of development of the module class.

4. (canceled)

5. An apparatus as claimed in claim 1, wherein each of the stage engineering module structures is a control level network and each of the stage engineering module structures comprises a plurality of task modules.

6. (canceled)

7. An apparatus as claimed in claim 5, wherein a task module of the plurality of task modules is arranged to support generation of at least part of the data relating to the function.

8. An apparatus as claimed in claim 2, wherein the data generated in relation to the function is indicative of further development required in respect of the module class.

9. An apparatus as claimed in claim 3, wherein the data at least relating to the function is indicative of a maturity mismatch between the performance attribute and the technology attribute.

10. An apparatus as claimed in claim 5, wherein the plurality of task modules comprises at least one of:
a requirements task module arranged to support access, when in use, to performance attribute data and prioritized requirements for a proposed design configuration;
an intellectual capital management task module arranged to support identification of, when in use, rights relating to a proposed design configuration;
a Stakeholder Management task module arranged to support provision, when in use, of investment case information;
a solutions task module arranged to support provision, when in use, of scientific and/or engineering information for providing a technical specification;
a critical analysis task module arranged to support performance, when in use, of critical analysis in respect of a proposed design configuration; and
a performance assessment task module arranged to support characterization, when in use, of performance of a proposed design configuration.

11. (canceled)

12. (canceled)

13. (canceled)

14. (canceled)

15. (canceled)

16. An apparatus as claimed in claim 10, wherein the requirements task module is operably coupled to the intellectual capital task module and the solutions task module.

17. An apparatus as claimed in claim 10, wherein the intellectual capital task module is operably coupled to the stakeholder management task module.

18. An apparatus as claimed in claim 10, wherein the solution task module is operably coupled to the critical analysis task module and the intellectual capital task module.

19. An apparatus as claimed in claim 10, wherein the critical analysis task module is operably coupled to the performance assessment task module and the requirements task module.

20. An apparatus as claimed in claim 1, wherein the plurality of stages comprises a first stage arranged to employ the stage engineering module structure in order to permit scientific validation of technology associated with a proposed design configuration.

21. An apparatus as claimed in claim 1, wherein the plurality of stages comprises a second stage arranged to employ the stage engineering module structure in order to permit verification that use of a technology is permitted or unconstrained in respect of a proposed design configuration based upon sociological restraint data.

22. An apparatus as claimed in claim 1, wherein the plurality of stages comprises a third stage arranged to employ the stage engineering module structure in order to permit determination as to whether a stakeholder in an organisation is capable of supporting development of a proposed design configuration.

23. An apparatus as claimed in claim 1, wherein the plurality of stages comprises at least one of:
a fourth stage arranged to employ the stage engineering module structure in order to permit determination as to whether project design resources are able to specify a solution for a proposed design configuration;
a fifth stage arranged to employ the stage engineering module structure in order to permit determination as to whether an enterprise is able to manufacture a product in accordance with a proposed design configuration;
a sixth stage arranged to employ the stage engineering module structure in order to permit determination as to whether an organization is able to provide adequate support to a customer in respect of a proposed design configuration; and
a seventh stage arranged to employ the stage engineering module structure in order to permit determination as to an impact resulting from operation of a proposed design configuration in a market.

24. (canceled)

25. (canceled)

26. (canceled)

27. An apparatus as claimed in claim 1, wherein the processing resource is arranged to support categorization of performance attributes into module classes.

28. An apparatus as claimed in claim 1, wherein the processing resource is arranged to support categorization of technology attributes into module classes.

29. A method of modelling a technology enterprise, the method comprising:
providing a stage and gateway process having a plurality of stages and a plurality of gateways interlaced with the plurality of stages; and
providing a plurality of stage engineering module structures respectively associated with the plurality of stages, each of the stage engineering module structures supporting, at least in part, a function associated with the stage and gateway process;
storing data at least relating to the function;
monitoring an assessment of the function at a stage of the stage and gateway process; and
managing progression to a succeeding adjacent stage of the stage and gateway process in response to the assessment.

30. A computer program code element comprising computer program code means to make a computer execute the method as claimed in claim 29.

31. (canceled)
